(19) United States
(12) Patent Application Publication
(10) Pub. No.: US 2008/0305310 A1
(43) Pub. Date: Dec. 11, 2008

(54) LUMINESCENT LAMINATE ACRYLIC SHEET AND METHOD

(76) Inventors: Eric S. Hausserman, Findlay, OH (US); Brad Rickle, Findlay, OH (US)

Correspondence Address: FRASER CLEMENS MARTIN & MILLER LLC, 28366 KENSINGTON LANE, PERRYSBURG, OH, 43551, US

(21) Appl. No.: 12/126,056

(22) Filed: May 23, 2008

Related U.S. Application Data
(60) Provisional application No. 60/942,321, filed on Jun. 6, 2007.

(51) Int. Cl. B32B 7/02; B32B 27/08; B29C 47/08; B32B 7/12

(52) U.S. Cl. 428/195.1; 428/515; 428/337; 428/339; 428/354; 428/215; 264/211.12; 156/60

(57) ABSTRACT

A luminescent laminate acrylic sheet and a method of making the sheet are disclosed. The sheet includes a luminescent layer bonded to at least one other acrylic layer, wherein the luminescent layer provides illumination to the sheet in low or no light environments. The method of producing the sheet includes extruding the various layers and then bonding the layers together under a compressive force and an elevated temperature in a flat lamination press.

### CROSS-REFERENCE TO RELATED APPLICATION

This application claims the benefit of U.S. Provisional Patent Application Ser. No. 60/942,321 filed on Jun. 6, 2007, hereby incorporated herein by reference in its entirety.

### FIELD OF THE INVENTION

The present invention relates to a laminate acrylic sheet, and more specifically to a laminate acrylic sheet having a luminescent layer formed therein.

### BACKGROUND OF THE INVENTION

Acrylic sheeting is widely used in the manufacture of signs and has proven to be a low cost durable material for many types of signage. The acrylic sheeting is often a laminate of two or more sheets to selectively provide a protective finish or cosmetic properties such as a desired color, for example, to the sheet.

Words and symbols must be added to the acrylic sheet to make the final desired sign. The words and symbols are typically either painted on the sheet or a vinyl cut-out of the desired letters and symbols are adhered to the sheet. The words and symbols could also be added to the sheet by an engraving process, provided the material properties of the acrylic have been adapted to facilitate engraving.

A sign constructed from a typical acrylic sheet must be illuminated by a source of light in order to be visible at night or under other conditions where natural light is not available. The addition of a light source to the sign significantly increases the installation and maintenance costs for the sign. Even with such a light source, the sign may not be visible in emergency situations where electrical power to the light source is interrupted. The information written on such signs is often at its greatest need during emergencies where the electrical power has been interrupted. A sign that can remain visible in the dark, even in the absence of electrical power, would facilitate the communication of the information displayed thereon to people in such emergency situations. In fact, some jurisdictions throughout the United States have passed laws that require luminescent signage to be used to mark escape routes in commercial buildings, New York City Local Law 26 being one example of such a law.

The manufacture of laminate acrylic sheeting involves a number of separate steps to bond the layers into a single sheet and prepare the final sheet for sale. The steps to achieve the final sheet are typically completed by two or more separate manufacturers. For example, one manufacture may produce acrylic sheets and sell them to a second manufacturer. The second manufacturer laminates the sheets together and employs various finishing steps to prepare the laminate sheet to sell to sign manufacturers. The multiple manufacturers typically involved with producing the final acrylic laminate sheet increase a cost thereof.

It would be desirable to provide a luminescent laminate acrylic sheet that is engravable, paintable, and facilitates the adhesion of cut-outs thereto, and can be formed using a streamlined process which minimizes a manufacturing cost thereof.

### SUMMARY OF THE INVENTION

Compatible and attuned with the present invention, a luminescent laminate acrylic sheet that is engravable, paintable, and facilitates the adhesion of cut-outs thereto, and can be formed using a streamlined process which minimizes a manufacturing cost thereof, has surprisingly been discovered.

In one embodiment, a luminescent laminate sheet comprises an extruded substrate layer formed from an acrylic resin extruded as a sheet; and an extruded luminescent layer formed from an acrylic resin including an acrylic base resin and a luminescent compound, the luminescent layer bonded to the substrate layer to provide a luminescent laminate sheet.

In another embodiment, a luminescent laminate sheet comprises a substrate layer formed from an acrylic resin including an acrylic base resin and at least one of a heat stabilized colorant, processing aid, and impact modifier extruded as a sheet having a thickness between about 0.0025 and 0.0075 inches; and a luminescent layer formed from an acrylic resin including a strontium oxide aluminate and an acrylic base resin extruded as a sheet having a thickness between about 0.010 and 0.020 inches, a ratio of the strontium oxide aluminate to the acrylic base resin being about one to four, the luminescent layer bonded to the substrate layer to provide a luminescent laminate sheet.

In another embodiment, a method for producing a luminescent laminate sheet comprising the steps of extruding a plurality of sheets from an acrylic resin, at least one sheet including a luminescent compound with the acrylic resin; and compressing the sheets with about 1300 psi at a temperature between about 260 to 270 degrees Fahrenheit to create a laminate thereof.

### BRIEF DESCRIPTION OF THE DRAWINGS

The above, as well as other advantages of the invention, will become readily apparent to those skilled in the art from the following detailed description of an embodiment of the invention when considered in the light of the accompanying drawings, in which:

FIG. 1 is a perspective view of a three-layer laminate acrylic sheet according to an embodiment of the invention with a portion cut-away to more clearly illustrate each laminate; and

FIG. 2 a perspective view of a two-layer laminate acrylic sheet according to another embodiment of the invention with a portion cut-away to more clearly illustrate each laminate.

### DETAILED DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

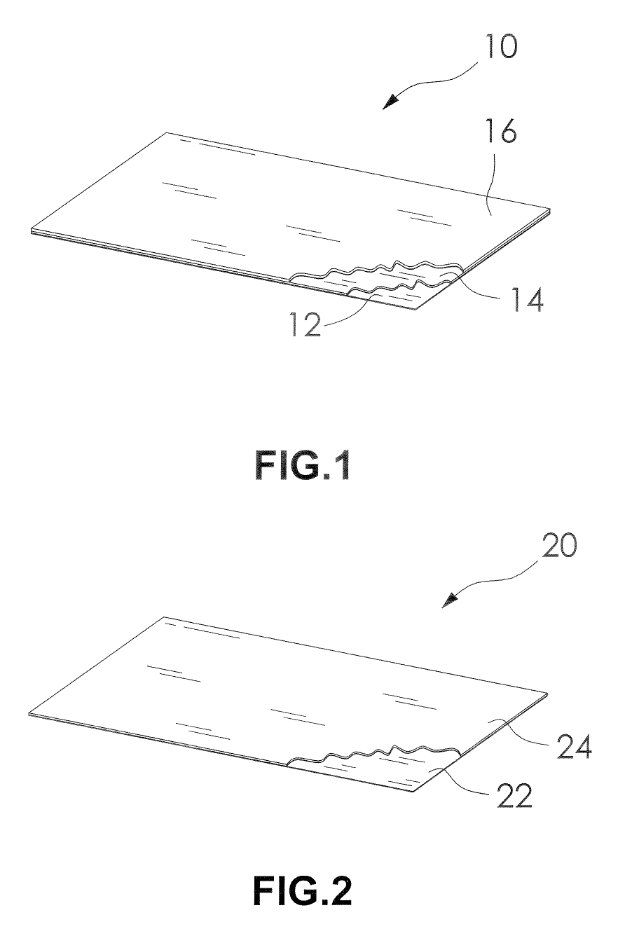

An engravable luminescent laminate acrylic sheet, generally indicated by reference numeral 10, is shown in FIG. 1. The laminate sheet 10 includes an engravable substrate layer 12 having a first surface and a spaced apart second surface. The substrate layer 12 is formed by extruding an impact modified acrylic resin as a substantially planar sheet. The resin includes a base resin. Favorable results have been obtained using such base resins from Altuglas International of Philadelphia, Pa., or Plaskolite, Inc. of Columbus, Ohio. It should be understood that other base resins can be used as desired. Additives can be included with the base resin such as colorants, processing aides, and impact modifiers, for example. Favorable results have been obtained using color additives having heat stabilizers that facilitate maintaining a desired color intensity under elevated temperatures. Favorable results have been obtained employing a thickness of the substrate layer 12 in the range of about 0.0025 to 0.0075 inches. It should be understood that other thicknesses can be used as desired.

An engravable luminescent layer 14 of the laminate sheet 10 is formed by extruding a luminescent compound as a substantially planar sheet having a first surface and a spaced apart second surface. The luminescent compound includes at least a modified acrylic base resin and a luminescent pigment including a strontium oxide aluminate. Favorable results have been obtained using such base resins from Altuglas International of Philadelphia, Pa. or Plaskolite, Inc. of Columbus, Ohio. It should be understood that other base resins can be used as desired. The strontium oxide aluminate imparts a luminescent property to the luminescent layer 14. Favorable results have been obtained employing a ratio of the strontium oxide aluminate to the base resin of about one to four. It should be understood that other ratios may be used to provide a desired luminescence to the luminescent layer 14. A luminescent pigment from Ampacet Corp. of Terrytown, N.Y., that includes the strontium oxide aluminate and is pre-mixed with the base resin has also exhibited satisfactory results. Additionally, favorable results have been obtained employing a thickness of the luminescent layer 14 in the range of about 0.010 to 0.020 inches. It should be understood that other thicknesses can be used as desired. The second surface of the luminescent layer 14 is bonded to the first surface of the substrate layer 12.

A substantially transparent layer 16 of the laminate sheet 10 is formed by extruding an acrylic resin as a substantially planar sheet having a first surface and a spaced apart second surface. The resin includes a base resin. Exemplary resins have been obtained from Altuglas International of Philadelphia, Pa. or Plaskolite, Inc. of Columbus, Ohio. It should be understood that other base resins can be used as desired. Additives can be included with the base resin such as processing aides and UV stabilizers, for example. A typical thickness of the transparent layer 16 is in the range of about 0.010 to 0.030 inches. It should be understood that other thicknesses can be used as desired. The second surface of the transparent layer 16 is bonded to the first surface of the luminescent layer 14, wherein the luminescence from the luminescent layer 14 is visible through transparent layer 16.

A masking material (not shown) is typically removably disposed on the first surface of the transparent layer 16 of the laminate sheet 10. The masking material provides a protective cover to the first surface of the laminate sheet 10 that militates against scratches thereon during shipment of the laminate sheet 10 or subsequent processes employed to manufacture a sign therefrom. The masking material is typically removed by an end user of the laminate sheet 10.

The three layer engravable laminate sheet 10 can be used to manufacture signs for use in industrial, commercial, and residential settings. The laminate sheet 10 is adapted to facilitate a reverse engraving process. Desired text and symbols are engraved in mirror from the second surface of the substrate layer 12 of the laminate sheet 10. The depth of the engraving is the combined thickness of the substrate layer 12 and the luminescent layer 14 causing only the transparent layer 16 to remain in the laminate sheet 10 in the engraved areas. When viewed from the transparent layer 16 of the laminate sheet 10, the text symbols are visible in a conventional, readable format. The interior of the engraved text symbols can be covered with an opaque material such as a paint or a cut-out, for example, to provide contrast to the areas of the laminate sheet 10 not engraved, facilitating the ease of reading the text and symbols.

When the sign is in a dark environment, the luminescent layer 14 forming the background of the sign causes the engraved text and symbols to be visible. The luminescent layer 14 is adapted to provide luminescence and maintain the visibility of the sign for extended periods of time, including lengths of time as required by various laws and standards such as ISO 17398, DIN 67 510 Parts 1-4, and the International Marine Organization, for example. Periods of luminescence up to 24 hours and longer have been observed using the laminate sheet 10 described herein. Additionally, the first surface of the transparent layer 16 is adapted to facilitate the application and adhesion thereto of an opaque material such as paint or a cut-out, for example, to form the sign text and symbols. The opaque material substantially blocks the luminescence of the luminescent layer 14 to provide contrast to the areas of the laminate sheet 10 not covered by the opaque material.

A luminescent laminate acrylic sheet, generally indicated by reference numeral 20, is shown in FIG. 2. The laminate sheet 20 includes layers substantially similar to the substrate layer 12 and the luminescent layer 14 described hereinabove as a substrate layer 22 and a luminescent layer 24, respectively. The two layers 22, 24 are bonded together to form the laminate sheet 20. An adhesive (not shown) is applied to the second surface of the substrate layer 22 of the laminate sheet 20. The adhesive provides means for attaching the laminate sheet 20, or a sign made from the laminate sheet 20, to a supporting structure such as a wall or other surface as desired. It should be understood that other means may be employed to attach the laminate sheet 20, or a sign made from the laminate sheet 20, to the supporting structure such as a threaded fastener or hook means, for example. A craft paper (not shown) or other removable sheet material is typically employed to cover the adhesive. An end user of the sign manufactured from the laminate sheet 20 removes the craft paper prior to applying the sign to a surface. Favorable results of applying the adhesive have been obtained using 3M™ adhesive transfer tape 9502 from 3M of St. Paul, Minn. It should be understood that other adhesives and transfer tapes can be used as desired. The first surface of the luminescent layer 24 is adapted to facilitate the application and adhesion thereto of cut-outs of the sign text and symbols. Additionally, the text and symbols for the sign can be applied to the luminescent layer 24 employing a screen printing or other printing means as desired.

A masking material (not shown) is typically removably disposed on the first surface of the luminescent layer 24 of the laminate sheet 20. The masking material provides a protective cover to the first surface of the luminescent layer 24 of the laminate sheet 20 that militates against scratches thereon during shipment of the laminate sheet 20 or subsequent processes employed to manufacture a sign therefrom. The masking material is typically removed during the final production of the sign or by an end user prior to displaying the sign.

The two layer laminate sheet 20 can be used to manufacture signs for use in industrial, commercial, and residential settings. When the sign is in a dark environment, the luminescent layer 24 of the laminate sheet 20 forms the background of the sign and causes the text and symbols applied to, or printed on, the luminescent layer 24 to be visible. The luminescent layer 24 is adapted to provide luminescence and maintain the visibility of the sign for extended periods of time, including lengths of time as required by various laws and standards such as ISO 17398, DIN 67 510 Parts 1-4, and the International Marine Organization, for example. Periods of luminescence up to 24 hours and longer have been observed using the laminate sheet 20 described herein.

A method for producing the luminescent laminate acrylic sheet 10 includes a first step of extruding the three layers 12, 14, 16 of the laminate sheet 10. Favorable results have been found using a screw type extruder to form substantially continuous and planar sheets. The acrylic resin for the layers 12, 14, 16 is typically provided to the extruder through a gravity feed system along with any other ingredients, including the luminescent compound for the luminescent layer 14, in a predetermined ratio utilizing a computerized control system. Favorable results have been obtained by extruding a substantially continuous and planar substrate layer 12 having a thickness of 0.005″. The continuous extrusion of the substrate layer 12 can be cut into 25″×50″ individual sheets. The luminescent layer 14 is extruded and cut in the substantially the same manner as the substrate layer 12. Favorable results have been obtained employing a thickness of 0.015″ for the luminescent layer 14. The transparent layer 16 is also extruded in the substantially the same manner is as the substrate layer 12. Favorable results have been obtained employing a thickness of 0.030″ for the transparent layer 16. It should be understood that other thicknesses and sheet sizes can be used as desired.

The layers 12, 14, 16 are bonded together to form the laminate sheet 10. The layers are bonded together using a flat lamination press (not shown) having at least a pair of movable spaced apart platens (not shown). A source of heat energy is provided to the platens to achieve a desired platen temperature.

A sheet of each layer 12, 14, 16 is provided and stacked in the indicated order in substantial alignment. The stacked layers 12, 14, 16 are placed between two chromed steel plates (not shown). The plates are at least as wide and as long as the layers 12, 14, 16. The plates, together with the layers 12, 14, 16 stacked therebetween, are placed between the platens of the lamination press. The lamination press causes a movement of the platens which minimizes a gap between outer surfaces thereof to compress the plates and layers 12, 14, 16. Additionally, the heat energy is transferred from the platens to the plates and the layers 12, 14, 16. The compressive force and the heat energy cooperate to cause the layers 12, 14, 16 to bond and form the laminate sheet 10. It should be understood that two or more laminate sheets 10 can be simultaneously formed therein by providing one or more additional steel plates to form a stacking order between the platens of a steel plate, a first laminate sheet 10, a second plate, a second laminate sheet 10, and a third plate. Favorable results have been obtained by employing five plates to simultaneously form four laminate sheets 10. Additionally, a sheet of material may be disposed between the plates and the laminate sheets 10 to form a desired surface finish thereto. Favorable results have been obtained by positioning a polyester material such as Mylar® sold by E.I. de Nemours and Company from Wilmington, Del., between one steel plate and the transparent layer 16 of the laminate sheet 10 to form a matte finish on the first surface of the transparent layer 16. It should be understood that other materials may be disposed between the plates and the laminate sheets 10 to form other desired surface finishes to the laminate sheet 10.

It is typically desirable to use a compression force of about 1300 psi and temperatures in the range of about 260 to 270 degrees Fahrenheit. It should be understood that other compression forces and temperatures can be used as desired.

The laminate sheet 10 is unloaded from the lamination press and processed through a lamination machine (not shown). The lamination machine employs silicone rollers to apply the masking material to the first surface of the laminate sheet 10. Upon emerging from the lamination machine, the laminate sheet 10 is typically transferred to means for shearing (not shown) to cut the laminate sheet 10 into a plurality of smaller dimensioned sheets as desired.

A method for producing the luminescent laminate acrylic sheet 20 includes a first step of extruding the substrate layer 22 and the luminescent layer 24 of the laminate sheet 20 in the same manner as described above for the layers 12, 14, 16 of laminate sheet 10. The layers 22, 24 are bonded together to form the laminate sheet 20. The layers 22, 24 are bonded together using the multi-platen flat lamination press previously described herein.

A sheet of the substrate layer 22 and the luminescent layer 24 are provided and stacked in substantial alignment. The stacked layers 22, 24 are placed between the two chromed steel platen plates of the platen. The plates are typically at least as wide and as long as the layers 22, 24. The plates, together with the layers 22, 24 stacked therebetween, are placed between the platens of the lamination press. The lamination press causes a movement of the platens which minimizes a gap between outer surfaces thereof to compress the plates and layers 22, 24. Additionally, the heat energy is transferred from the platens to the plates and layers 22, 24. The compressive force and the heat energy cooperate to cause the layers 22, 24 to bond and form the laminate sheet 20. It should be understood that two or more laminate sheets 20 can be simultaneously formed therein by providing one or more additional steel plates to form a stacking order between the platens of a steel plate, a first laminate sheet 20, a second plate, a second laminate sheet 20, and a third plate. Favorable results have been obtained by employing five plates to simultaneously form four laminate sheets 20. Additionally, a sheet of material may be disposed between the plates and the laminate sheets 20 to form a desired surface finish thereto. A sheet of polyester material such as Mylar® sold by E.I. du Pont de Nemours and Company from Wilmington, Del., can be positioned between one steel plate and the luminescent layer 24 of the laminate sheet 20 to form a matte finish to the first surface of the luminescent layer 24. It should be understood that other materials may be disposed between the plates and the laminate sheets 20 to form other desired surface finishes to the laminate sheet 20.

It is typically desirable to use a compression force of about 1300 psi and temperatures in the range of about 260 to 270 degrees Fahrenheit. It should be understood that other compression forces and temperatures can be used as desired.

The laminate sheet 20 is unloaded from the lamination press and processed through the lamination machine to apply the masking material to the first surface of the laminate sheet 20. Additionally, the lamination machine is employed to apply the adhesive and/or adhesive transfer tape to a second surface of the laminate sheet 20. Upon emerging from the lamination machine, the laminate sheet 20 is typically transferred to the means for shearing to cut the laminate sheet 20 into a plurality of smaller dimensioned sheets as desired.

The methods for producing the laminate sheet 10 and the laminate sheet 20 minimize a cost thereof by simplifying the manufacturing process and the costs associated with the typical manufacturing process of laminate sheets that require multiple manufacturers.

From the foregoing description, one ordinarily skilled in the art can easily ascertain the essential characteristics of this invention, and without departing from the spirit and scope thereof, can make various changes and modifications to the invention to adapt it to various usages and conditions.

What is claimed is:

1. A luminescent laminate sheet comprising:
an extruded substrate layer formed from an acrylic resin extruded as a sheet; and
an extruded luminescent layer formed from an acrylic resin including an acrylic base resin and a luminescent compound, the luminescent layer bonded to the substrate layer to provide a luminescent laminate sheet.

2. The laminate sheet according to claim 1, wherein the acrylic resin of the substrate layer includes an acrylic base resin and at least one of a heat stabilized colorant, processing aid, and impact modifier.

3. The laminate sheet according to claim 1, wherein a thickness of the substrate layer is between about 0.0025 and 0.0075 inches.

4. The laminate sheet according to claim 1, wherein the luminescent compound is a strontium oxide aluminate.

5. The laminate sheet according to claim 4, wherein a ratio of the strontium oxide aluminate to the acrylic base resin is about one to four.

6. The laminate sheet according to claim 1, wherein a thickness of the luminescent layer is between about 0.010 and 0.020 inches.

7. The laminate sheet according to claim 1, wherein an opaque material is disposed at selected locations on a surface of the luminescent layer substantially blocking the luminescence of the luminescent layer at the selected locations.

8. The laminate sheet according to claim 1 including a masking material removably disposed on a surface of the luminescent layer to militate against a damage thereto.

9. The laminate sheet according to claim 1 including an adhesive material disposed on a surface of the substrate layer to facilitate securing the laminate sheet to a supporting structure.

10. The laminate sheet according to claim 4 including a substantially transparent layer formed from an acrylic resin and bonded to the luminescent layer to provide a luminescent three layer laminate sheet.

11. The laminate sheet according to claim 10, wherein a thickness of the substrate layer is between about 0.0025 and 0.0075 inches, a thickness of the luminescent layer is between about 0.010 and 0.020 inches, and a thickness of the transparent layer is between about 0.010 and 0.030 inches.

12. The laminate sheet according to claim 8, wherein an opaque material is disposed at selected locations on a surface of the transparent layer substantially blocking the luminescence of the luminescent layer at the selected locations.

13. The laminate sheet according to claim 8, wherein the substrate layer and the luminescent layer are engravable.

14. The laminate sheet according to claim 8 including a masking material removably disposed on a surface of the transparent layer to militate against a damage thereto.

15. The laminate sheet according to claim 8 including an adhesive material disposed on a surface of the substrate layer to facilitate securing the laminate sheet to a supporting structure.

16. A luminescent laminate sheet comprising:
a substrate layer formed from an acrylic resin including an acrylic base resin and at least one of a heat stabilized colorant, processing aid, and impact modifier extruded as a sheet having a thickness between about 0.0025 and 0.0075 inches; and
a luminescent layer formed from an acrylic resin including a strontium oxide aluminate and an acrylic base resin extruded as a sheet having a thickness between about 0.010 and 0.020 inches, a ratio of the strontium oxide aluminate to the acrylic base resin being about one to four, the luminescent layer bonded to the substrate layer to provide a luminescent laminate sheet.

17. The laminate sheet according to claim 16 including a substantially transparent layer formed from an acrylic resin extruded as a sheet having a thickness between about 0.010 and 0.030 inches and bonded to the luminescent layer to provide a luminescent three layer laminate sheet.

18. A method for producing a luminescent laminate sheet comprising the steps of:
extruding a plurality of sheets from an acrylic resin, at least one sheet including a luminescent compound with the acrylic resin; and
compressing the sheets with about 1300 psi at a temperature between about 260 to 270 degrees Fahrenheit to create a laminate thereof.

19. The method according to claim 18, including the step of cutting the laminate sheet into a plurality of laminate sheets.

20. The method according to claim 18, including the step of applying a removable masking material to a surface of the laminate sheet to militate against a damage to the surface.
